(19) United States
(12) Patent Application Publication
(10) Pub. No.: US 2004/0108440 A1
(43) Pub. Date: Jun. 10, 2004

(54) Harrison free standing towers and missile defense system

(76) Inventor: Wilbur Ernest Harrison, Catonsville, MD (US)

Correspondence Address: WILBUR E. HARRISON, JR., 226 STONEWALL ROAD, CATONSVILLE, MD, 21228-5443, US

(21) Appl. No.: 10/065,872

(22) Filed: Nov. 26, 2002

(51) Int. Cl. F16M 13/00

(52) U.S. Cl. 248/550

(57) ABSTRACT

Free Standing Towers and defensive systems that support and provide surveillance radar, communication systems and defense systems against cruise missiles, ICBMs, manned and unmanned aircraft by providing the lowest cost option for positioning systems where look-down surveillance, look-over-the-natural horizon surveillance and high electric power requirements are a major consideration.

### DETAILED DESCRIPTION

Free Standing Towers that support and contain anti-missile defense surveillance radar, communications systems and defensive weapons systems to protect and defend the USA and it's Allies against enemy cruise missiles, ICBMs and manned or unmanned aircraft. Also this invention provides border defense for the USA and it's Allies. Defensive weapons would include, but not be limited to, anti-missile missiles, USA defensive aircraft, directed energy weapons such as, but would nor be limited to, HEL (High Energy Laser) weapons and HECW (High Energy Carrier Wave) weapons. The entire system described above would providethe lowest cost option for positioning defensive systems where look-down surveillance, look over-the-natural-horizon surveillance, look-up surveillance and high electric power requirements are a major consideration.

The design technique would include: 1. the use of large gyroscopes to provide tower stability. Our research of the literature and the Internet (See our list of references, as listed in Attachments: Attachment A) indicates no claims for the use of gyroscopes to stabilize unsupported (No cables of support) radar towers, communication towersor guyed cable supported towers. Thus, this application is NOT INCLUDED IN THE PUBLIC DOMAIN. 2. According to our professional experience and calculations, these gyroscopes will be firmly and rigidly attached and secured to the towers every 100 feet of tower height, the gyroscopes' axis of rotation will be the same as the tower vertical center line, the gyroscopes will weigh some 10,000 lbs, (with most of the gyroscope rotating member weight concentrated at the rotating member perimeter) and the gyroscope rotating member will rotate at 15,000 RPM. 3. The tower verticle support members shall be round in cross section, will be made of a clear material (such as Lucite) and will contain photo-electric panels to generate electric power. 4. The towers shall have wind power electric power generators attached as often as is practicle. We plan to attach to attach such wind power electric power generators every 50 feet of tower height. 5. Radar antennas shall be attached to the tower at or near the tower top and attached every 1000 feet or so of the tower height. 6. The antenna and equipment shall be protected from weather by clear air supported air supported cable reinforsed structures similar to those shown in pictures on www.HAlholdings.com (located on Architectural & Engineering Page of the WEBSITE). 7. An elevator shall be attached to each tower to enable access to the radar antennas, radar equipment and other servicing as needed or required for calibration or adjustment.

1. The use of gyroscopes to stabilize radar towers, communication towers, towers designed for defensefrom cruise missiles, ICBMs, manned or unmanned aircraft (Drones), perimeter defense of all types and for recreation or advertising purposes.

2. The use of clear structural members (such as Lucite) suitable to contain phoroelectric panels panels for the purpose of generating electric power.

3. The use of wind power electric power generators for generating electric power on high towers.

4. The use of high free standing towers to support radar, communication and other antennas and equipment.

5. The use of plastic clear (such as Mylar Polyester Film) and reinforced cloth (such as Hypalon) to protect radar antennas, radar equipment, other military defense equipment, other communication antennas and equipment that are installed on high towers (free standing towers and/or guyed towers) and protected by air supported structures made of any material.

6. The use of elevators (enclosed or not enclosed) to construct, service, maintain, view, or for any other purpose installed on high (1000 feet or higher) free standing or guyed towers intended for military, communication, commercial, or entertainment or pleasure purposes.
